(19) United States
(12) Patent Application Publication
(10) Pub. No.: US 2023/0027252 A1
(43) Pub. Date: Jan. 26, 2023

(54) SORTING AND DRYING TECHNIQUES FOR OFF-GROUND HARVESTED ALMONDS

(71) Applicant: THE REGENTS OF THE UNIVERSITY OF CALIFORNIA, Oakland, CA (US)

(72) Inventors: Zhongli PAN, Davis, CA (US); Ragab KHIR, Davis, CA (US)

(21) Appl. No.: 17/783,477

(22) PCT Filed: Jun. 17, 2021
(86) PCT No.: PCT/US2020/064057

§ 371 Date: Jun. 8, 2022

Related U.S. Application Data
(60) Provisional application No. 62/945,772, filed on Dec. 9, 2019.

(51) Int. Cl. A23N 5/00

(52) U.S. Cl. CPC A23N 5/008

(57) ABSTRACT

In some embodiments, a method for processing almonds includes sorting almonds into groups; and drying the sorted almonds. Sorting the almonds may include sorting based a size, a dimension, a mass, and/or an aerodynamic property. Drying the almonds includes subjecting the almonds to heated air for a time period and further include circulating the heated air at a velocity.

### CROSS-REFERENCE TO RELATED APPLICATIONS

This application claims priority to U.S. Patent Provisional Application 62/945,772 filed Dec. 9, 2019, the entire contents of which is incorporated by reference.

### BACKGROUND

Almonds are an important agricultural product. Almonds may be harvested or collected from trees by shaking the nuts onto the ground to dry and then sweeping and picking up the nuts from the ground (on-ground harvesting). Alternatively, almonds may be harvested by an off-ground method where the nuts are shaken off the tree and caught by a catch frame above the ground. On-ground harvesting allows the nuts to dry on the ground and does not require additional drying. Off-ground harvesting requires artificial drying. It would be beneficial to develop an energy efficient method of artificially drying off-ground harvested nuts.

### SUMMARY

According to one aspect, a method for processing almonds includes sorting almonds, hulling of in-hull almonds before or after sorting and drying the sorted almonds.

According to another aspect, a method for sorting almonds includes a first sorting method and a second sorting method.

According to another aspect, a method for drying almonds includes subjecting the almonds to a temperature in the range of approximately 50° C. to approximately 90° C. for a time period.

### BRIEF DESCRIPTION OF DRAWINGS

This written disclosure describes illustrative embodiments that are non-limiting and non-exhaustive. Reference is made to illustrative embodiments that are depicted in the figures, in which:

FIG. 1 is a flowchart illustrating a sorting method used in an almond processing method according to some embodiments of this disclosure.

FIG. 2 is an illustration of a system used in an almond processing method according to some embodiments of this disclosure.

FIG. 3 is an illustration of a system used to sort almonds according to some embodiments of this disclosure.

FIG. 4 is an illustration of a system used to dry almonds according to some embodiments of this disclosure.

FIG. 5 is an illustration of a system used in an almond processing method according to some embodiments of this disclosure.

FIG. 6 is a flowchart illustrating an almond processing method according to some embodiments of this disclosure.

FIG. 7 is a flowchart illustrating an almond processing method according to some embodiments of this disclosure.

FIGS. 8A-C are graphs showing the cutoff size for sorting the (A) Nonpareil, (B) Monterey, and (C) Fritz variety of almonds into groups of empty hulls, in-hull almonds, and in-shell almonds.

FIGS. 9A-C are graphs showing the terminal velocity for sorting the (A) Nonpareil, (B) Monterey, and (C) Fritz variety of almonds into groups of empty hulls and in-hull almonds.

FIGS. 10A-C are graphs showing energy consumption by a column drying at different drying conditions (temperature and air speed) for (A) Nonpareil, (B) Monterey, and (C) Fritz almond varieties, respectively.

FIG. 11 is a graph of drying curves for in-shell and in-hull almonds with different initial moisture contents for a temperature of 60° C. and an air speed of 2 m/s.

FIGS. 12A-B are graphs of final product kernel whiteness index at different drying temperatures and air speeds for the Nonpareil almond variety. FIG. 12A is at an air speed of 1 m/s and FIG. 12B is at an air speed of 2 m/s.

FIGS. 13A-B are graphs of the peroxide value (FIG. 13A) and free fatty acids (FIG. 13B) of the Nonpareil, Fritz, and Monterey almond varieties at different temperatures and air speeds after benchtop drying.

FIGS. 14A-B are graphs of concealed damage of Nonpareil variety of almonds dried at different temperatures at 1 m/s (FIG. 14A) and at 2 m/s (FIG. 14B).

### DETAILED DESCRIPTION

An almond tree fruit (hereinafter referred to as almond) has a hull enclosing a shell that surrounds a kernel. The kernel is the portion of the almond that is consumed. Almonds harvested or collected from almond trees are a mixture of intact almonds (in-hull almonds), almonds without the hull (in-shell almonds), and empty hulls.

When on-ground harvested almonds are swept up from the ground after being dried, significant particulate air pollution over a wide area may be created. This particulate air pollution can impact public health. Additionally, on-ground harvested almonds may experience microbial contamination or insect damage. Harvesting almonds off-ground minimizes particulate air pollution since the harvested almonds are caught by a catch frame above the ground. However, off-ground harvesting requires artificial drying of the almonds—as opposed to allowing the almonds to dry on the ground. Artificially drying off-ground harvested almonds can be time consuming and energy intensive. For example, it was observed that when unsorted almonds were dried most of the energy was used to dry the empty hulls. The almond processing method and system described herein sorts the harvested almonds before drying to improve product quality, to increase processing efficiency, the drying rate, energy efficiency, throughput capacity, and to provide dried almonds with a uniform moisture content. In some embodiments, the disclosed almond processing method reduces drying time by 45% and/or reduces the energy use by more than 50%.

Varieties of almonds include Nonpareil, Monterey, Fritz, and Independence. Almond varieties may have different axial dimensions (Table 1), moisture content distributions (Table 2), weight ratio of fractions (Table 3), and/or bulk densities (kg/m³). For example, a bulk density of 320, 290, and 380 kg/m³ was observed experimentally for the Independence, Monterey, and Fritz almond varieties respectively.

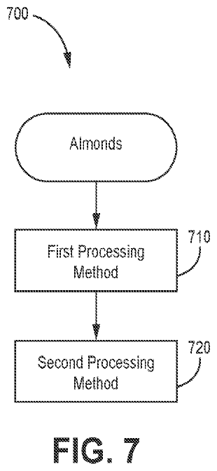

In at least one embodiment, an almond processing method as described herein has a first processing step and a second processing step. FIG. 7 shows an embodiment of an almond processing method 700 with a first processing step 710 and a second processing step 720. In this embodiment of the almond processing method 700, the first processing step 710 is a sorting method and the second processing step 720 is a drying method. In additional embodiments of the almond processing method as described herein, the processing method further includes a de-hulling step to remove the hull from in-hull almonds, i.e. dehull the in-hull almonds, before the second processing step. The de-hulling step may be done before the almonds are sorted or after the almonds are sorted. In embodiments of the almond processing method described herein, the empty hulls are separated from the non-empty hulls (in-shell almonds and in-hull almonds) and only the non-empty hulls are dried. Although empty hulls are considered to be a waste output of the almond processing methods disclosed herein, the empty hulls may be distributed for additional processing.

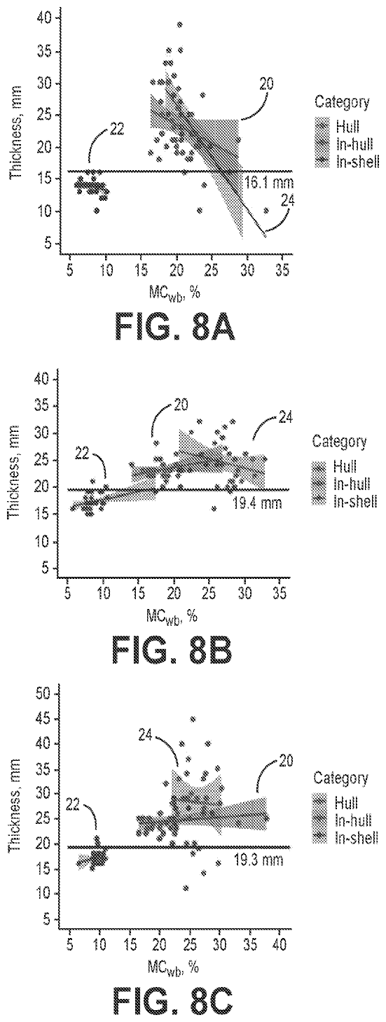

In some embodiments, the first processing step sorts almonds into three groups: in-hull almonds, in-shell almonds, and empty hulls. In some embodiments, the sorting method sorts almonds into groups based on a size value, e.g. length, width, and/or thickness. Table 1 shows averages and standard deviations of axial dimensions of different categories for three different almond varieties. As shown in Table 1, the dimensions of in-hull almonds are significantly greater than those of in-shell almonds. In some embodiments of the sorting method, a thickness value is used to sort/separate/group in-shell almonds from in-hull almonds and empty hulls. It was observed experimentally that when thickness values of 16.1 mm, 19.4 mm, and 19.3 mm were used, about 85%, 86%, and 77% of in-shell almonds 22 were separated from in-hull almonds 20 and empty hulls 24 for the Nonpareil, Monterey, and Fritz almond varieties, respectively (see FIGS. 8A-C). Experimentally, a sorting method using a thickness value has a mis-classification error rate of 15%-23% empty hulls in the group of in-shell almonds was observed.

TABLE 1

| | | Axial dimensions (mm) | | |
|---|---|---|---|---|
| Variety | Category | Length | Width | Thickness |
| Nonpareil | In-hull | 37.53 ± 2.71 | 28.00 ± 2.52 | 23.63 ± 4.41 |
| | In-shell | 33.63 ± 2.43 | 21.80 ± 1.85 | 13.80 ± 1.21 |
| | Empty hull | 38.13 ± 2.57 | 27.33 ± 4.23 | 23.70 ± 7.11 |
| Monterey | In-hull | 38.27 ± 3.22 | 24.80 ± 2.28 | 23.20 ± 1.99 |
| | In-shell | 37.97 ± 3.00 | 22.23 ± 1.50 | 17.37 ± 1.40 |
| | Empty hull | 40.20 ± 2.99 | 24.77 ± 4.43 | 24.30 ± 3.78 |
| Fritz | In-hull | 35.93 ± 2.70 | 24.10 ± 2.45 | 24.47 ± 2.47 |
| | In-shell | 32.47 ± 2.69 | 20.33 ± 1.63 | 17.17 ± 1.26 |
| | Empty hull | 36.27 ± 2.98 | 22.70 ± 6.08 | 28.27 ± 7.86 |

In some embodiments of the sorting method, sorting almonds into groups is based on an aerodynamic property. Aerodynamic properties of almonds include dimensions (e.g. length, width, thickness), mass or weight, and terminal velocity. A cylindrical air column may be used to determine a terminal velocity for an almond variety. Table 2 shows the weight ratios of empty hulls, in-shell almonds, and in-hull almonds for different almond varieties. As can be seen in Table 2, in-hull almonds formed the largest fraction. Additionally, there was a large fraction of empty hulls. Aerodynamic sorting can be used to separate in-hull almonds from the empty hulls or separate the empty hulls from non-empty hulls (in-shell almonds and in-hull almonds).

TABLE 2

| | Weight Ratio | | |
|---|---|---|---|
| | Empty | In- | In- |
| Variety | Hull | shell | hull |
| Independence | 0.32 | 0.17 | 0.51 |
| Monterey | 0.16 | 0.28 | 0.56 |
| Fritz | 0.12 | 0.16 | 0.72 |
| Monterey | 0.14 | 0.12 | 0.74 |

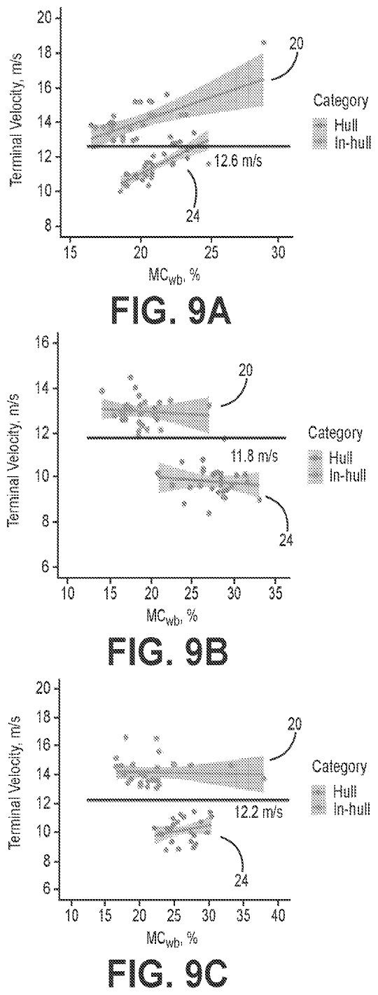

It was observed experimentally that when an air velocity is set at 12.6 m/s, 11.8 m/s, and 12.2 m/s, about 90%, 96%, and 100% of empty hulls 24 can be separated from in-hull almonds 20 for the Nonpareil, Monterey, and Fritz almond varieties, respectively (see FIGS. 9A-C). Experimentally, sorting with terminal air velocity has a mis-classification error rate of 4% to 10% empty hulls with the group of in-hull almonds.

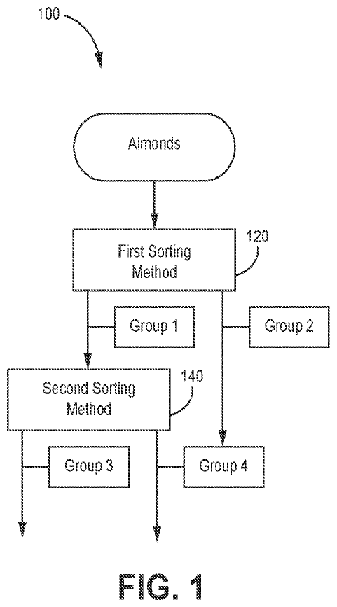

FIG. 1 is a flowchart of an exemplary sorting method 100. The sorting method 100 includes a first sorting method 120 and a second sorting method 140 to sort almonds into three groups: in-hull almonds, in-shell almonds, and empty hulls. In some embodiments of the sorting method 100, the first sorting method 120 sorts the almonds by an initial characteristic and the second sorting method 140 further sorts by a drying characteristic.

As shown in FIG. 1 the first sorting method 120 separates the almonds into two groups, Group 1 and Group 2, and the second sorting method 140 separates Group 1 into two sub-groups, Group 3 and Group 4. In one example of the sorting method 100, size sorting may be used for the first sorting method and aerodynamic sorting used for the second sorting method 140. For this first exemplary sorting method 100, Group 1 is a mixture of in-hull almonds and empty hulls, Group 2 is in-shell almonds, Group 3 is in-hull almonds, and Group 4 is empty hulls. In another example of the sorting method 100, aerodynamic sorting may be used for the first sorting method 120 and size sorting used for the second sorting method 140. For this second exemplary sorting method 100, Group 1 is a mixture of in-shell almonds and in-hull almonds, Group 2 is empty hulls, Group 3 is in-hull almonds, and Group 4 is in-shell almonds.

A benefit of the sorting method is that in-hull almonds and in-shell almonds are separated before being dried. Table 3 shows the initial moisture content distribution of almonds harvested using an off-ground harvesting method. Several trends are shown in Table 3. First, the overall moisture content of almond varieties differs. Second, the moisture content of in-hull almonds is much higher than in-shell almonds. It was also experimentally observed that the range of initial moisture content for in-hull almonds was wider than for in-shell almonds. Third, the kernel moisture content for in-hull almonds was greater than for in-shell almonds.

TABLE 3

| | Moisture Content Distribution (%) | | | | | |
|---|---|---|---|---|---|---|
| | | In-hull | | | In-shell | |
| Variety | Overall | Empty Hull | Shell | Kernel | Shell | Kernel |
| Nonpareil | 20.9 | 23.7 | 9.2 | 7.8 | 8.7 | 6.1 |
| | | (13.3-46.9) | (5.4-16.5) | (3.2-20.2) | (5.9-11.1) | (3.0-10.7) |
| Monterey | 17.7 | 19.8 | 10.0 | 8.4 | 8.4 | 6.5 |
| | | (12.2-51.9) | (6.7-25.5) | (3.6-23.3) | (5.9-15.1) | (3.5-19.3) |
| Fritz | 20.8 | 27.1 | 13 | 13 | 9.9 | 6.5 |
| | | (12.4-55.7) | (3.6-32.5) | (3.6-32.5) | (6.4-13.2) | (3.4-15.8) |

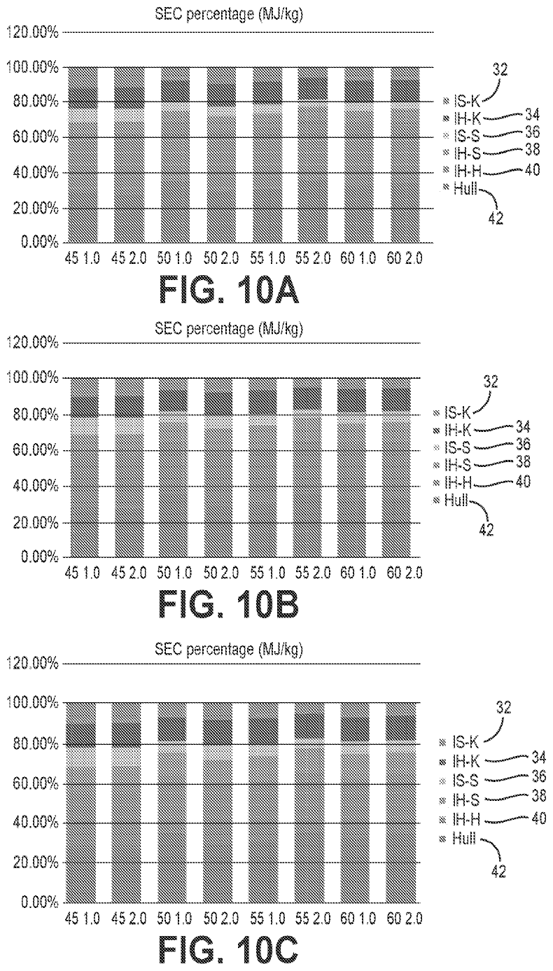

A benefit of the first processing step of the almond processing method embodiments disclosed herein is that the empty hulls are eliminated before the drying process. As can be seen in Table 2, the weight ratio of the empty hull fraction for different varieties can range from 0.12 to 0.32. Eliminating empty hulls before the drying process reduces energy consumption and the drying time. For example, it was observed experimentally that when unsorted almonds were dried, up to 65% of the energy was used to dry the empty hulls and only about 20% of the energy was used to dry the kernel/almond (see FIGS. 10A-C). FIGS. 10A-C are graphs of the percentage of specific energy consumption (SEC) (MJ/kg) by a column dryer at different temperatures for in-shell kernels 32, in-hull kernels 34, in-shell-shells 36, in-hull-shells 38, in-hull-hulls 40, and empty hulls 42 for Nonpareil (FIG. 10A), Monterey (FIG. 10B), and Fritz (FIG. 10C) varieties of almonds. It was also observed experimentally that the drying of in-hull and in-shell almonds separately can reduce the energy use by more than 50%.

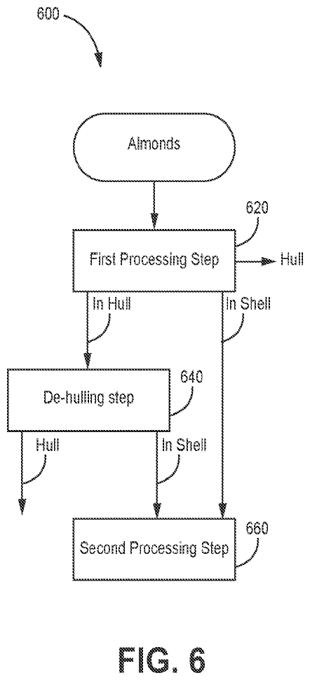

In some embodiments, the almond processing method further includes a de-hulling step to remove the hull from in-hull almonds. The de-hulling step may be done before the almonds are sorted or after the almonds are sorted. Benefits of de-hulling the in-hull almonds before drying include a shorter drying time and/or lower energy consumption for the second processing step. FIG. 6 illustrates a flowchart of an embodiment of an almond processing method 600 that includes a de-hulling step 640. The first processing step 620 sorts the harvested almonds into groups: in-hull almonds, in-shell almonds, and empty hulls. The in-hull almonds undergo a de-hulling step 640 to produce in-shell almonds. In-shell almonds, from the first processing step and from the de-hulling step 640, undergo a second processing step 606, the drying step.

In some embodiments, the second processing step uses a method to dry almonds. The method to dry almonds reduces the moisture of the almonds from an initial moisture content to a final moisture content. Drying may be conducted using a continuous process or a batch process. In some embodiments, the drying device includes a probe to monitor an environmental condition and/or an internal condition of the batch of almonds being dried.

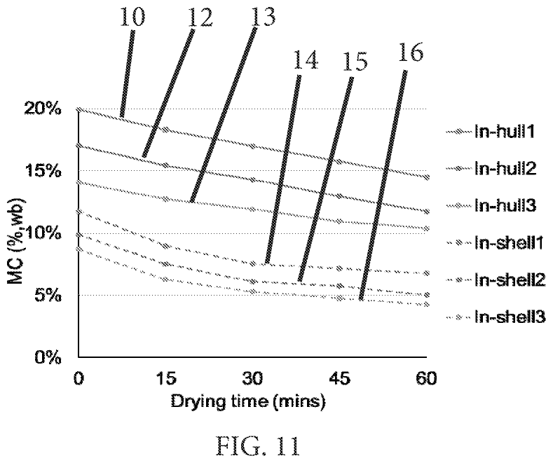

For some embodiments, the almonds are dried for approximately 1 hour to approximately 2.5 hours. Some embodiments further include using hot air to reduce the moisture content. In at least one embodiment, in-hull almonds and in-shell almonds are dried separately. As discussed above, in-hull almonds and in-shell almonds have different moisture content qualities. A benefit of drying in-hull almonds separately from in-shell almonds is that the selection of a drying temperature and/or drying time may be based on the initial moisture content of the almonds being dried. FIG. 11 is a graph of drying curves for in-shell almonds 14, 15, 16 and in-hull almonds 10, 12, 13 with different initial moisture contents at a temperature of 60° C. and an air speed of 2 m/s. A comparison of the drying curves for the in-hull almonds 10, 12, 13 to the drying curves for the in-shell almonds 14, 15, 16 show that the in-hull almonds have a higher initial moisture content and would require longer drying times to achieve a final moisture content less than 10% compared to the in-shell almonds.

In some embodiments of a method to dry almonds, temperatures of approximately 50° C. to approximately 85° C. are used to reduce the moisture content of the almonds. It was observed experimentally that drying almonds at a constant 60° C. temperature led to an 80% reduction in drying time compared to ambient drying.

In an example method for drying almonds, almonds were subjected to a temperature in the range of approximately 55° C. to approximately 85° C. for approximately 0.5 hour to approximately 2.5 hours.

In other embodiments of a method to dry almonds, temperatures of approximately 50° C. to approximately 90° C. are used to reduce the moisture content of the almonds in the second processing step. It was observed experimentally that a drying temperature of approximately 90° C. did not negatively affect the product quality because no significant differences in kernel color, oil quality, concealed damage and/or cavity were observed. Experiments also showed that pre-heating with 90° C. hot air resulted in lower energy cost than pre-heating with 80° C. hot air. Additionally, it was observed that the drying time of in-shell almonds was much shorter (2.5 hour) compared to the drying time of in-hull almonds (10 hour) from the same harvest batch. A 77% lower energy cost was also observed for drying in-shell almonds compared to drying in-hull almonds from the same harvest batch. A reduction in drying time, greater throughput, and/or lower energy costs are benefits of the de-hulling step discussed above.

It was observed that commercial dryers can achieve a desired moisture content in 5.6 to 24.0 hours. When a temperature of 54° C. was used it was experimentally observed that drying trailer, drying tunnel, and stadium dryer achieved rapid drying (5.8 to 48.0 hours).

In some embodiments, a stepwise drying process was used for the second processing step. In some implementations of a stepwise drying process, almonds (in-hull or in-shell) are dried at a first temperature for a first time period followed by a second lower temperature for a second time period. In one example, the first temperature is up to 80° C. and the second temperature is in the range of 50-70° C. In one particular example almonds were subjected to a first temperature in the range of approximately 75° C. to approximately 80° C. for a first time period of approximately 0.5 hour to approximately 1 hour and then to a second temperature in the range of approximately 60° C. to approximately 65° C. and a second time period of approximately 1 hour to approximately 2.5 hours. In some embodiments, a feedback unit receiving input from a probe controls the amount of time at the higher temperature.

In an example of a stepwise drying process, almonds were subjected to a first temperature in the range of approximately 75° C. to approximately 85° C. for approximately 0.5 hour to approximately 1 hour, and a second temperature in the range of approximately 60° C. to approximately 70° C. for approximately 1 hour to approximately 2.5 hours.

In a second example of a stepwise drying process, almonds were subjected to a first temperature in the range of approximately 75° C. to approximately 80° C. for approximately 0.5 hour to approximately 1 hour, and a second temperature in the range of approximately 60° C. to approximately 70° C. for approximately 1 hour to approximately 2.5 hours.

In a third example of a stepwise drying process, almonds were subjected to a first temperature in the range of approximately 75° C. to approximately 80° C. for approximately 0.5 hour to approximately 1 hour, and a second temperature in the range of approximately 60° C. to approximately 65° C. for approximately 1 hour to approximately 2.5 hours.

Benefits of hot air drying methods described herein include a higher drying rate/reduced drying time, lower insect infestation rate (0.8-3.3% compared to 2.0-10%), a bright kernel color, and uniform moisture. It was observed experimentally that using high temperature reduced the drying time by 45% (see FIG. 11). It was also observed experimentally that high energy efficiency and low operation cost was achieved when almonds were dried at a temperature of 55° C. In some embodiments, drying the almonds at 60° C. for approximately 30 minutes to 2 hours is sufficient to kill insects in the almonds being dried. It was observed that less time was needed to kill insects when a temperature greater 60° C. was used to dry the almonds.

The method of drying almonds may further include circulating air within the dryer at an air speed. An air speed of approximately 0 m/s to approximately 5 m/s may be used for the second processing step. A benefit observed when a higher air speed was used in a column dryer is that the distribution of final product moisture was more uniform. It was also observed experimentally that it took only 1, 1.5, and 1.75 hours to dry the Nonpareil, Fritz, and Monterey almond varieties from the initial moisture content to a final moisture content when an air temperature of 60° C. and an air velocity of 2 m/s were used. In comparison, the respective dry times were 2, 3, and 4.3 hours when an air temperature of 45° C. and an air velocity of 1 m/s were used.

In some embodiments of a method of drying almonds, the method further includes monitoring an environmental condition and/or an internal condition of the almonds. A probe may be used to monitor/measured the condition(s). Examples of conditions that may be monitored/measured include temperature, moisture content, and/or air speed. The method of drying the almonds may further include modifying an environmental condition when a measured condition exceeds a threshold condition. In some embodiments, the measured conditions may be supplied to a feedback control unit that may be used to automatically modify an environmental condition when a measured condition exceeds a threshold condition.

It was observed experimentally that in-shell almonds dried faster and more uniformly than in-hull almonds. For example, after drying for a period of time, in-shell almonds had a final moisture content of 5-8% while in-hull almonds had a final moisture content above 10%. Thus, if a mixture of in-hull almonds and in-shell almonds were dried to a targeted final kernel moisture content of 6% and drying was stopped when the in-shell almonds reached the target moisture content, the in-hull almonds would still be wet after the drying step. Wet almonds can pose a health and safety issue. Alternatively, if the drying of a mixture of in-hull almonds and in-shell almonds was stopped when the in-hull almonds reached the target moisture content, the in-shell almonds would be over-dried and the quality of the in-shell almonds may be affected. Thus, benefits of drying in-shell almonds and in-hull almonds separately include a decrease in the amount of wet product present after drying and/or a more uniform moisture content.

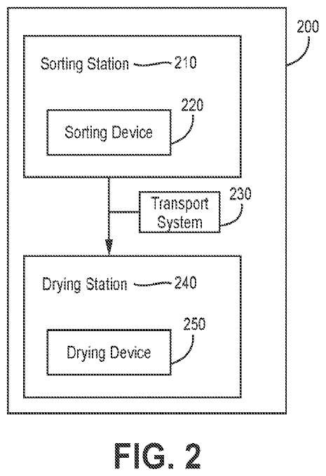

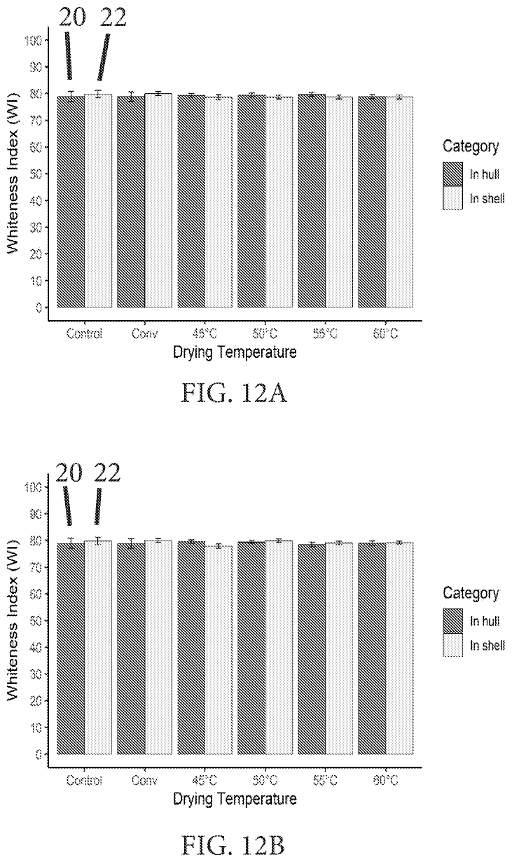

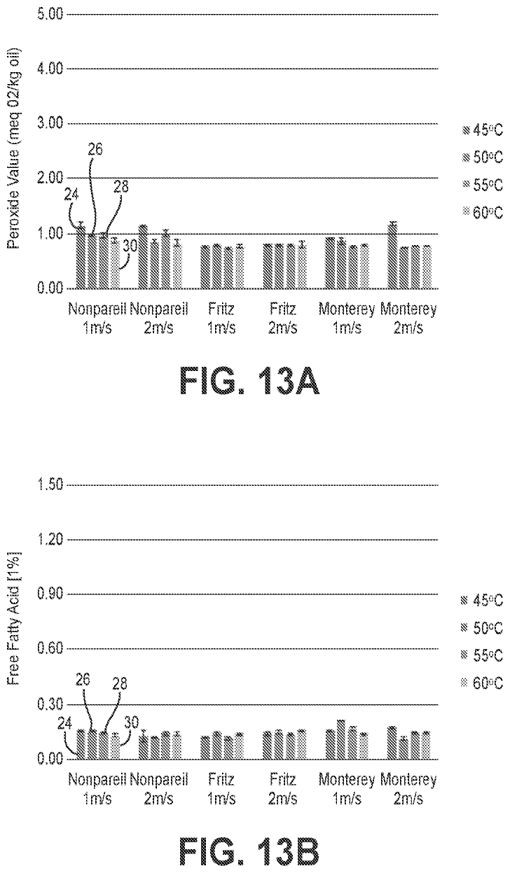

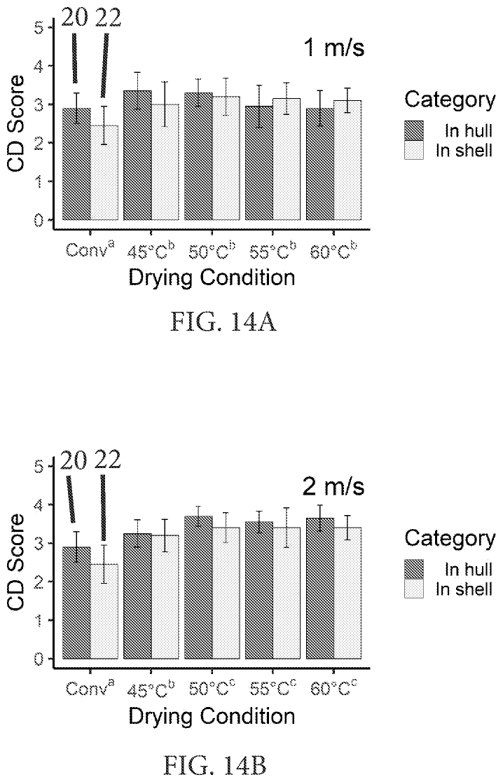

Other benefits of the almond processing method embodiments disclosed herein include improvements in processing efficiency, throughput capacity, energy efficiency, drying rate, and product quality. Quality indicators of almonds include kernel color, cavity, and concealed damage. It was observed experimentally that dried in-shell almonds and in-hull almonds did not experience cavity. It was also observed that there were no adverse effects on color change and concealed damage of dried almonds when a high drying temperature was used. For example, almonds dried using a temperature of 60° C. and an air velocity of 2 m/s were observed to have no cavity, no change in color, no change in oil quality, and no severe concealed damage. FIGS. 12A-B are graphs comparing the final product kernel whiteness index of in-hull 20 and in-shell 22 groups of the Nonpareil variety of almonds dried at different temperatures with an air speed of 1 m/sec (FIG. 12A) or 2 m/s (FIG. 12B). As can be seen in FIGS. 12A-B, almonds dried at higher temperatures have a whiteness index comparable to the control and conventional drying. FIG. 13A is a graph of the peroxide values measured for different varieties of almonds (Nonpareil, Fritz, and Monterey), that were dried an air speed of 1 m/s or 2 m/s, at different temperatures 24 (45° C.), 26 (50° C.), 28 (55° C.), and 30 (60° C.). FIG. 13A shows that the peroxide values are much lower than the industry standard of 5 meq O₂/kg oil. FIG. 13B is a graph of the free fatty acid percentage for different varieties of almonds (Nonpareil, Fritz, and Monterey), with an air speed of 1 m/s or 2 m/s at different temperatures 24 (45° C.), 26 (50° C.), 28 (55° C.), and 30 (60° C.). FIG. 13B shows that the free fatty acid percentages are much lower than the industry standard of 1.5%. FIGS. 14A-B are graphs comparing the amount of concealed damage observed when in-hull 20 and in-shell 22 groups of the Nonpareil variety of almonds were dried at different temperatures at an air speed of 1 m/sec (FIG. 14A) or 2 m/s (FIG. 14B). The ability to use temperatures up to 80° C.-90° C. to dry almonds was unexpected.

In at least one embodiment, a system to process almonds includes a sorting station and a drying station. In some embodiments, the system further includes a de-hulling station to dehull the in-hull almonds. In additional embodiments, the system further includes a transport system. The sorting station, the de-hulling station, and/or the drying station may be in the same building or location, or in different buildings or locations. In some embodiments, the sorting station is in a first building and the drying station is in a second building. In a further embodiment, the de-hulling station is in a third building.

At the sorting station, the almonds are sorted into groups of in-hull almonds, in-shell almonds, and/or empty hulls using a sorting method described herein. Examples of sorting devices that may be used for sorting stations, systems and for almond processing methods described herein, include a mesh, pore or variable pore belt conveyor, roller conveyor belt, a sieve, hand sorting, an air knife, a wind tunnel, and/or a terminal velocity device.

At the drying station, almonds are dried using a drying method disclosed herein. Examples of drying devices that may be used in drying stations, systems, and for almond processing methods described herein, include a band oven, a drying chamber, a column dryer, drying trailers, drying tunnels, and/or stadium dryers. Environmental conditions in the drying station and/or a drying device and/or internal conditions of the batch of almonds being dried may be monitored by a probe. Examples of probes that may be used include a temperature probe, a moisture probe, and/or an air speed probe. The drying station may further include a feedback control unit and/or an air circulation unit.

A transport system as discussed herein may be used to move almonds between devices in a station, e.g. from a first sorting device to a second sorting device, and/or between stations, e.g. from the sorting station to the drying station. Examples of transport systems that may be used in the systems and for almond processing methods described above include transport by hand, conveyors, trucks, and/or trains. Some exemplary conveyors include, but are not limited to, chutes, conveyor belts, aeromechanical conveyors, bucket elevators, and/or pneumatic conveying systems (e.g. vacuum conveying, pressure conveying, vacuum pressure conveying).

FIG. 2 shows an example of a system 200 to process almonds that includes a sorting station 210 with a sorting device 220, a drying station 240 with a drying device 250, and a transport system 230. In this system 200, the first and/or second sorting methods may be conducted at a sorting station 210 with at least one sorting device 220. Groups of in-hull almonds and in-shell almonds are moved by the transport system 230 from the sorting station 210 to the drying station 240 where they are dried using a drying method described herein.

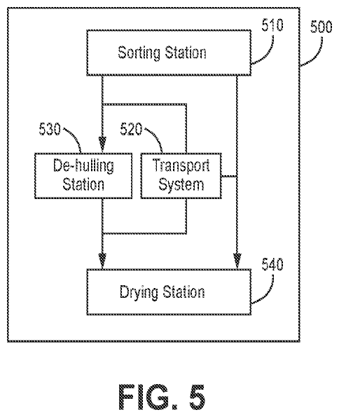

FIG. 5 shows an example of a system 500 that includes a sorting station 510, a de-hulling station 530, a drying station 540, and at least one transport system 520. In this system 500, the first and/or second sorting methods may be conducted at a sorting station 510 with at least one sorting device. At the sorting station 510 the harvested almonds are sorted into in-shell almonds, in-hull almonds, and empty hulls. The transport system 520 moves the in-hull almonds to a de-hulling station where the hulls from the in-hull almonds are removed to produce in-shell almonds. The transport system 520 also moves in-shell almonds from the sorting station 510 and the de-hulling station 520 to the drying station 530 to undergo a drying method. The movement of empty hulls out of the sorting station by a transport system is not shown.

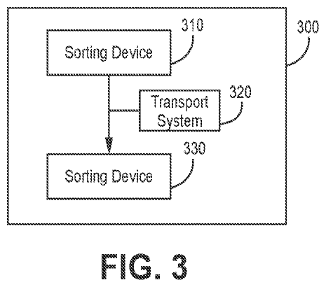

A system for a sorting station includes at least one sorting device. In some embodiments, the system further includes a transport system. FIG. 3 shows an example of a system 300 for a sorting station that includes a first sorting device 310, a second sorting device 330, and a transport system 320. At least some of the almonds sorted by the first sorting device 310 are moved by a transport system 320 to the second sorting device 330 for further sorting. The movement of empty hulls out of the sorting station by a transport system is not shown.

A system for a drying station includes at least one drying device. In some embodiments, the system further includes an air circulation unit. In at least one embodiment, the system further includes a probe. In some embodiments, the probe may be positioned in the drying device. In additional embodiments, the system further includes a feedback unit configured to receive input about an environmental condition and/or an internal condition of the almonds. Examples of conditions that may be monitored/measured include temperature, moisture content, and/or air speed. In some embodiments, the feedback unit receives input from a probe. In at least one embodiment, the feedback control unit controls/modifies an environmental condition when a measured condition exceeds a threshold condition.

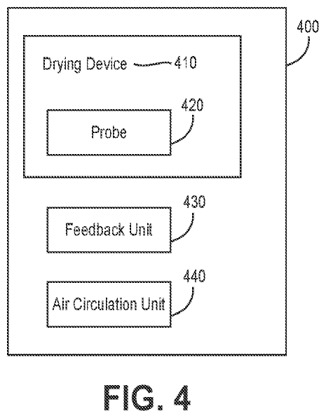

In at least one embodiment, the temperature of a drying device is lowered when a threshold temperature is reached. In some embodiments, the threshold temperature is approximately 65° C. In some embodiments the temperature probe is constructed and arranged to monitor an internal temperature of the almonds during the drying process. In some embodiments, the moisture probe is constructed and arranged to monitor an internal moisture of the almonds during the drying process. FIG. 4 shows an example of a system 400 for a drying station that includes a drying device 410 with a probe 420, a feedback unit 430, and an air circulation unit 440.

### DISCUSSION OF POSSIBLE EMBODIMENTS

According to an aspect, a method for processing almonds includes sorting the almonds; and drying the sorted almonds.

The system of the preceding paragraph can optionally include, additionally and/or alternatively any, one or more of the following features, configurations, and/or additional components.

For example, in some embodiments sorting the almonds separates empty hulls from non-empty hulls and drying the sorted almonds includes drying only the non-empty hulls.

In some embodiments, sorting the almonds includes a first sorting method and a second sorting method, and sorting almonds separates the almonds into three groups: in-shell almonds, in-hull almonds, and empty hulls.

In some embodiments, the first and second sorting methods sort the almonds based on a characteristic selected from the group consisting of a size, a dimension, a mass, and an aerodynamic property.

In some embodiments, the almonds are sorted into in-shell almonds, in-hull almonds, and empty hulls.

In some embodiments, sorting the almonds includes a first sorting method to sort the almonds into in-shell almonds and a mixture of in-hull almonds and empty hulls.

In some embodiments, sorting the almonds includes a second sorting method to sort the mixture of in-hull almonds and empty hulls into in-hull almonds and empty hulls.

In some embodiments, sorting the almonds includes a first sorting method to sort the almonds into empty hulls and a mixture of in-shell almonds and in-hull almonds.

In some embodiments, sorting the almonds includes a second sorting method to sort the mixture of in-shell almonds and in-hull almonds into in-shell almonds and in-hull almonds.

In some embodiments, the method includes de-hulling the in-hull almonds.

In some embodiments, the method includes de-hulling the in-hull almonds before the almonds are sorted.

In some embodiments, the method includes de-hulling the in-hull almonds after the almonds are sorted.

In some embodiments, drying the sorted almonds includes subjecting the sorted almonds to a temperature selected from the group consisting of: approximately 60° C. to approximately 80° C., approximately 65° C. to approximately 80° C., and approximately 70° C. to approximately 80° C.

In some embodiments, drying the sorted almonds includes subjecting the sorted almonds to a temperature in the range of approximately 50° C. to approximately 85° C.

In some embodiments, drying the sorted almonds includes subjecting the sorted almonds to a temperature selected from the group consisting of: approximately 60° C. to approximately 90° C., approximately 65° C. to approximately 90° C., and approximately 70° C. to approximately 90° C.

In some embodiments, drying the sorted almonds includes subjecting the sorted almonds to a temperature in the range of approximately 50° C. to approximately 90° C.

In some embodiments, drying the sorted almonds includes subjecting the sorted almonds to an air speed of approximately 0 m/s to approximately 5 m/s.

In some embodiments, the air speed is selected from the group consisting of: approximately 0 m/s to approximately 5 m/s, approximately 1 m/s to approximately 4 m/s, and approximately 2 m/s to approximately 3 m/s.

In some embodiments, drying the sorted almonds includes drying for a time period of approximately 0.5 hour to approximately 2.5 hours.

In some embodiments, drying the sorted almonds includes drying for a time period selected from the group consisting of approximately 1 hour to approximately 2.5 hours, approximately 1.5 hours to approximately 2.5 hours, and approximately 2 hours to approximately 2.5 hours.

According to another aspect, a method of sorting almonds includes sorting the almonds using a first sorting method; and sorting the almonds using a second sorting method.

The system of the preceding paragraph can optionally include, additionally and/or alternatively any, one or more of the following features, configurations, and/or additional components.

For example, in some embodiments, the method of sorting almonds separates the almonds into empty hulls, in-hull almonds, and in-shell almonds.

In some embodiments, the first and second sorting methods sort the almonds based on a characteristic selected from the group consisting of a size, a dimension, a mass, and a terminal velocity.

In some embodiments, the first sorting method sorts the almonds into in-shell almonds and a mixture of in-hull almonds and empty hulls.

In some embodiments, the first sorting method sorts the almonds into empty hulls and a mixture of in-shell almonds and in-hull almonds.

According to another aspect, a method of drying almonds to a desired moisture content includes subjecting the almonds to a temperature in the range of approximately 50° C. to approximately 85° C. for a time period.

The system of the preceding paragraph can optionally include, additionally and/or alternatively any, one or more of the following features, configurations, and/or additional components.

For example, in some embodiments the method of drying almonds includes subjecting the almonds to an air speed of approximately 0 m/s to approximately 5 m/s.

In some embodiments, the air speed is selected from the group consisting of: approximately 0 m/s to approximately 5 m/s, approximately 1 m/s to approximately 4 m/s, and approximately 2 m/s to approximately 3 m/s.

In some embodiments, the temperature includes a first temperature and a second temperature lower than the first temperature.

In some embodiments, a maximum for the first temperature is approximately 80° C. and a maximum for the second temperature is approximately 70° C.

In some embodiments, drying the sorted almonds includes subjecting the sorted almonds to a temperature selected from the group consisting of: approximately 60° C. to approximately 80° C., approximately 65° C. to approximately 80° C., and approximately 70° C. to approximately 80° C.

In some embodiments, drying the sorted almonds includes subjecting the sorted almonds to a temperature selected from the group consisting of: approximately 60° C. to approximately 90° C., approximately 65° C. to approximately 90° C., and approximately 70° C. to approximately 90° C.

In some embodiments, the time period is approximately 0.5 hour to approximately 2.5 hours.

In some embodiments, the time period is selected from the group consisting of approximately 1 hour to approximately 2.5 hours, approximately 1.5 hours to approximately 2.5 hours, and approximately 2 hours to approximately 2.5 hours.

According to another aspect, a method of drying almonds to a desired moisture content includes subjecting the almonds to a temperature in the range of approximately 50° C. to approximately 90° C. for a time period.

The system of the preceding paragraph can optionally include, additionally and/or alternatively any, one or more of the following features, configurations, and/or additional components.

For example, in some embodiments the method of drying almonds includes subjecting the almonds to an air speed of approximately 0 m/s to approximately 5 m/s.

In some embodiments, the air speed is selected from the group consisting of: approximately 0 m/s to approximately 5 m/s, approximately 1 m/s to approximately 4 m/s, and approximately 2 m/s to approximately 3 m/s.

In some embodiments, drying the sorted almonds includes subjecting the sorted almonds to a temperature selected from the group consisting of approximately 60° C. to approximately 90° C., approximately 65° C. to approximately 90° C., and approximately 70° C. to approximately 90° C.

In some embodiments, the temperature includes a first temperature and a second temperature lower than the first temperature.

In some embodiments, a maximum for the first temperature is approximately 90° C. and a maximum for the second temperature is approximately 70° C.

In some embodiments, the time period is approximately 0.5 hour to approximately 2.5 hours.

In some embodiments, the time period is selected from the group consisting of approximately 1 hour to approximately 2.5 hours, approximately 1.5 hours to approximately 2.5 hours, and approximately 2 hours to approximately 2.5 hours.

According to another aspect, a system for processing almonds includes a sorting station.

The system of the preceding paragraph can optionally include, additionally and/or alternatively any, one or more of the following features, configurations, and/or additional components.

For example, in some embodiments the system for processing almonds includes a de-hulling station.

In some embodiments, the system for processing almonds includes a drying station.

In some embodiments, a system for processing almonds includes a transport system. The transport system may move almonds between devices in a station and/or between stations.

In some embodiments, the transport system moves almonds to the sorting station, from the sorting station to the de-hulling station, and from the de-hulling station to the drying station.

In some embodiments, the transport system moves almonds to the de-hulling station, from the de-hulling station to the sorting station, and from the sorting station to the drying station.

According to another aspect, a system for a sorting station includes at least one sorting device.

The system of the preceding paragraph can optionally include, additionally and/or alternatively any, one or more of the following features, configurations, and/or additional components.

In some embodiments, the sorting station includes a first sorting device and a second sorting device.

In some embodiments, the system includes a transport system.

According to another aspect, a system for a drying station includes at least one drying device.

The system of the preceding paragraph can optionally include, additionally and/or alternatively any, one or more of the following features, configurations, and/or additional components.

In some embodiments, the system for a drying station includes an air circulation unit.

In some embodiment, the drying device includes a probe.

In some embodiments, the system includes a feedback unit configured to receive input from a probe and to change a parameter used to dry the almonds.

Other embodiments of the present disclosure are possible. Although the description above contains much specificity, these should not be construed as limiting the scope of the disclosure, but as merely providing illustrations of some of the presently preferred embodiments of this disclosure. It is also contemplated that various combinations or sub-combinations of the specific features and aspects of the embodiments may be made and still fall within the scope of this disclosure. It should be understood that various features and aspects of the disclosed embodiments can be combined with or substituted for one another in order to form various embodiments. Thus, it is intended that the scope of at least some of the present disclosure should not be limited by the particular disclosed embodiments described above.

Thus the scope of this disclosure should be determined by the appended claims and their legal equivalents. Therefore, it will be appreciated that the scope of the present disclosure fully encompasses other embodiments which may become obvious to those skilled in the art, and that the scope of the present disclosure is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

The foregoing description of various preferred embodiments of the disclosure have been presented for purposes of illustration and description. It is not intended to be exhaustive or to limit the disclosure to the precise embodiments, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto

Various examples have been described. These and other examples are within the scope of the following claims.

What is claimed is:

1. A method for processing almonds comprising:
sorting the almonds; and
drying the sorted almonds.

2. The method of claim 1, wherein sorting the almonds separates empty hulls from non-empty hulls and drying the sorted almonds includes drying only the non-empty hulls.

3. The method of claim 1, wherein sorting the almonds comprises a first sorting method and a second sorting method and sorting almonds separates the almonds into three groups: in-shell almonds, in-hull almonds, and empty hulls.

4. The method of claim 3, wherein the first and second sorting methods sort the almonds based on a characteristic selected from the group consisting of a size, a dimension, a mass, and an aerodynamic property.

5. The method of claim 1, wherein the almonds are sorted into in-shell almonds, in-hull almonds, and empty hulls.

6. The method of claim 1, wherein sorting the almonds comprises a first sorting method to sort the almonds into in-shell almonds and a mixture of in-hull almonds and empty hulls.

7. The method of claim 6, wherein sorting the almonds comprises a second sorting method to sort the mixture of in-hull almonds and empty hulls into in-hull almonds and empty hulls.

8. The method of claim 1, wherein sorting the almonds comprises a first sorting method to sort the almonds into empty hulls and a mixture of in-shell almonds and in-hull almonds.

9. The method of claim 8, wherein sorting the almonds comprises a second sorting method to sort the mixture of in-shell almonds and in-hull almonds into in-shell almonds and in-hull almonds.

10. The method of claim 1, wherein drying the sorted almonds comprises subjecting the sorted almonds to a temperature in the range of approximately 50° C. to approximately 90° C.

11. The method of claim 10, wherein drying the sorted almonds further comprises subjecting the sorted almonds to an air speed of approximately 0 m/s to approximately 5 m/s.

12. A method of sorting almonds comprising:
sorting the almonds using a first sorting method; and
sorting the almonds using a second sorting method.

13. The method of claim 12, wherein the method of sorting almonds separates the almonds into empty hulls, in-hull almonds, and in-shell almonds.

14. The method of claim 12, wherein the first and second sorting methods sort the almonds based on a characteristic selected from the group consisting of a size, a dimension, a mass, and a terminal velocity.

15. The method of claim 12, wherein the first sorting method sorts the almonds into in-shell almonds and a mixture of in-hull almonds and empty hulls.

16. The method of claim 12, wherein the first sorting method sorts the almonds into empty hulls and a mixture of in-shell almonds and in-hull almonds.

17. A method of drying almonds to a desired moisture content comprising:
subjecting the almonds to a temperature in the range of approximately 50° C. to approximately 90° C. for a time period.

18. The method of claim 17, further comprising subjecting the almonds to an air speed of approximately 0 m/s to approximately 5 m/s.

19. The method of claim 17, the temperature including a first temperature and a second temperature lower than the first temperature.

20. The method of claim 19, wherein a maximum for the first temperature is approximately 90° C. and a maximum for the second temperature is approximately 70° C.
